(19) United States
(12) Patent Application Publication
(10) Pub. No.: US 2007/0035622 A1
(43) Pub. Date: Feb. 15, 2007

(54) Method and apparatus for video surveillance

(76) Inventors: Keith J. Hanna, Princeton JCT, NJ (US); Manoj Aggarwal, Lawrenceville, NJ (US); Harpreet Sawhney, West Windsor, NJ (US)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 11/141,811

(22) Filed: Jun. 1, 2005

Related U.S. Application Data
(60) Provisional application No. 60/575,974, filed on Jun. 1, 2004.

(51) Int. Cl. H04N 7/18; H04N 5/225

(52) U.S. Cl. 348/143; 348/169

(57) ABSTRACT

A method and apparatus for performing video surveillance of a field of view is disclosed. In one embodiment, a method for performing surveillance of the field of view includes monitoring the field of view and detecting a moving object in the field of view, where the motion is detected based on a spatio-temporal signature (e.g., a set of descriptive feature vectors) of the moving object.

### CROSS-REFERENCE TO RELATED APPLICATIONS

This application claims benefit of U.S. provisional patent application Ser. No. 60/575,974, filed Jun. 1, 2004, which is herein incorporated by reference in its entirety.

### BACKGROUND OF THE INVENTION

The need for effective surveillance and security at airports, nuclear power plants and other secure locations is more pressing than ever. Organizations responsible for conducting such surveillance typically deploy a plurality of sensors (e.g., video and infrared cameras, radars, etc.) to provide physical security and wide-area awareness. For example, across the United States, an estimated nine million video security cameras are in use.

Typical vision-based surveillance systems depend on low-level video tracking as a means of alerting an operator to an event. If detected motion (e.g., as defined by flow) exceeds a predefined threshold, an alarm is generated. While such systems provide improved performance over earlier pixel-change detection systems, they still tend to exhibit a relatively high false alarm rate. The high false alarm rate is due, in part, to the fact that low-level detection and tracking algorithms do not adapt well to different imager and scene conditions (e.g., the same tracking rules apply in, say, an airport and a sea scene). In addition, the high-level analysis and rule-based systems that post-process the tracking data for decision making (alarm generation) are typically simplistic and fail to reflect many real world scenarios (e.g., a person returning a few feet through an airport exit to retrieve a dropped object will typically trigger an alarm even if the person resumes his path through the exit).

Thus, there is a need in the art for an improved method and apparatus for video surveillance.

### SUMMARY OF THE INVENTION

A method and apparatus for performing video surveillance of a field of view is disclosed. In one embodiment, a method for performing surveillance of the field of view includes monitoring the field of view and detecting a moving object in the field of view, where the motion is detected based on a spatio-temporal signature (e.g., a set of descriptive feature vectors) of the moving object.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram illustrating one embodiment of a method for video surveillance, according to the present invention;

FIG. 2 is a flow diagram illustrating one embodiment of a method for determining whether to generate an alert in response to a newly detected moving object, according to the present invention;

FIG. 3 is a flow diagram illustrating one embodiment of a method for learning alarm events, according to the present invention; and

FIG. 4 is a high level block diagram of the surveillance method that is implemented using a general purpose computing device.

### DETAILED DESCRIPTION

The present invention discloses a method and apparatus for providing improved surveillance and motion detection by defining a moving object according to a plurality of feature vectors, rather than according to just a single feature vector. The plurality of feature vectors provides a richer set of information upon which to analyze and characterize detected motion, thereby improving the accuracy of surveillance methods and substantially reducing false alarm rates (e.g., triggered by environmental movement such as swaying trees, wind, etc. and other normal, real world events for which existing surveillance systems do not account).

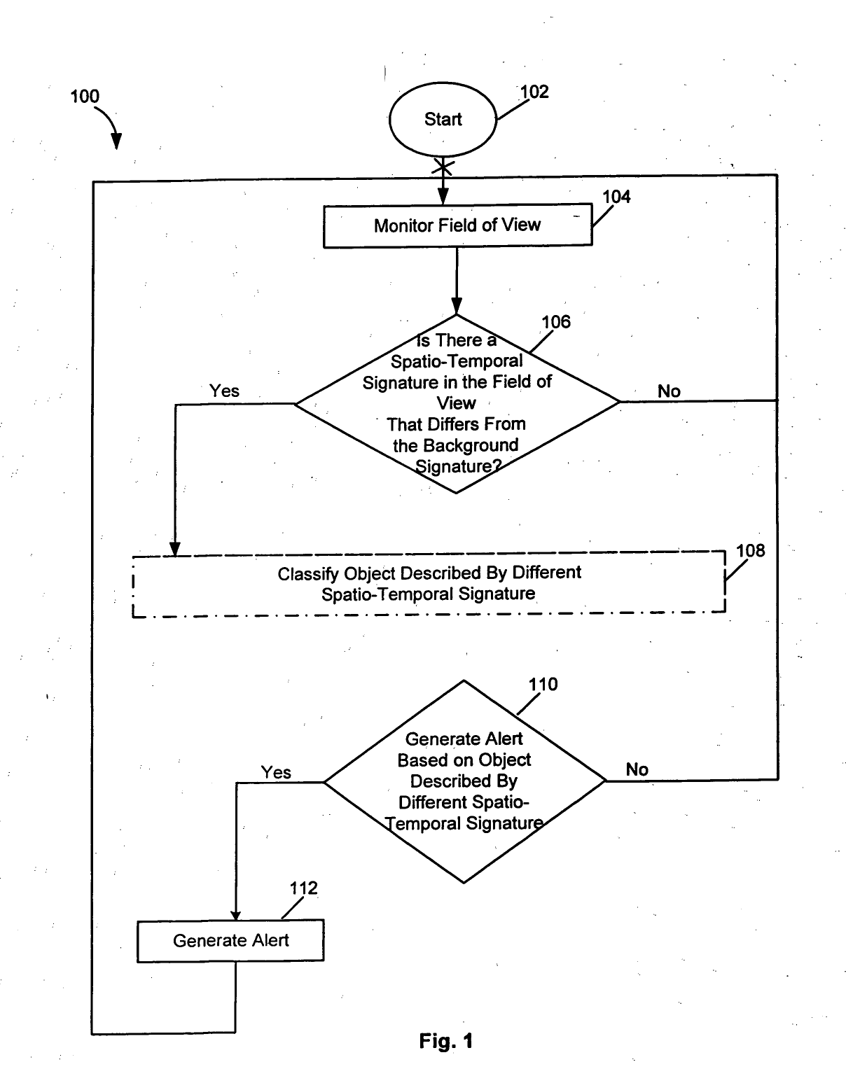

FIG. 1 is a flow diagram illustrating one embodiment of a method 100 for video surveillance, according to the present invention. The method 100 may be implemented, for example, in a surveillance system that includes one or more image capturing devices (e.g., video cameras) positioned to monitor a field of view. For example, one embodiment of a motion detection and tracking system that may be advantageously adapted to benefit from the present invention is described in U.S. Pat. No. 6,303,920, issued Oct. 16, 2001.

The method 100 is initialized in step 102 and proceeds to step 104, where the method 100 monitors the field of view (e.g., at least a portion of the area under surveillance). In step 106, the method 100 detects an object (e.g., a person, an animal, a vehicle, etc.) moving within the field of view. Specifically, the method 100 detects the moving object by determining whether a spatio-temporal signature of an object moving in the field of view differs from the spatio-temporal signatures associated with the background (e.g., due to movement in the background such as swaying trees or weather conditions), or does not “fit” one or more spatio-temporal signatures that are expected to be observed within the background. In one embodiment, an object's spatio-temporal signature comprises a set (e.g., a plurality) of feature vectors that describe the object and its motion over a space-time interval.

The feature vectors describing a background scene will differ significantly from the feature vectors describing a moving object appearing in the background scene. For example, if the monitored field of view is a sea scene, the spatio-temporal signatures associated with the background might describe the flow of the water, the sway of the trees or the weather conditions (e.g., wind, rain). The spatio-temporal signature of a person walking through the sea scene might describe the person's size, his velocity or the swing of his arms. Thus, motion in the field of view may be detected by detecting the difference in the spatio-temporal signature of the person relative to the spatio-temporal signatures associated with the background. In one embodiment, the method 100 may have access to one or more stored sets of spatio-temporal features that describe particular background conditions or scenes (e.g., airport, ocean, etc.) and movement that is expected to occur therein.

Once a moving object has been detected by the method 100 (e.g., in accordance with the spatio-temporal signature differences), the method 100 optionally proceeds to step 108 and classifies the detected object based on its spatio-temporal signature. As described above, an object's spatio-temporal signature provides a rich set of information about the object and its motion. This set of information can be used to classify the object with a relatively high degree of accuracy. For example, a person walking across the field of view might have two feature vectors or signatures associated with his motion: a first given by his velocity as he walks and a second given by the motion of his limbs (e.g., gait, swinging arms) as he walks. In addition, the person's size may also be part of his spatio-temporal signature. Thus, this person's spatio-temporal signature provides a rich set of data that can be used to identify him as person rather than, for example, a dog or a car. As a further example, different vehicle types may be distinguished by their relative spatio-temporal signatures (e.g., sedans, SUVs, sports cars). In one embodiment, such classification is performed in accordance with any known classifier method.

For example, in some embodiments, object classification in accordance with optional step 108 includes comparing the detected object's spatio-temporal signature to the spatio-temporal signatures of one or more learned objects (e.g., as stored in a database). That is, by comparing the spatio-temporal signature of the detected object to the spatio-temporal signatures of known objects, the detected object may be classified according to the known object that it most closely resembles at the spatio-temporal signature level. In one embodiment, a detected object may be saved as a new learned object (e.g., if the detected object does not resemble at least one learned object within a predefined threshold of similarity) based on the detection performance of the method 100 and/or on user feedback. In another embodiment, existing learned objects may be modified based on the detection performance of the method 100 and/or on user feedback.

Thus, if the method 100 determines in step 106 that a spatio-temporal signature differing from the spatio-temporal signatures associated with the background scene is present, the method 100 determines that a moving object has been detected, proceeds (directly or indirectly via step 108) to step 110 and determines whether to generate an alert. In one embodiment, the determination of whether to generate an alert is based simply on whether a moving object has been detected (e.g., if a moving object is detected, generate an alert). In further embodiments, the alert may be generated not just on the basis of a detected moving object, but on the features of the detected moving object as described by the object's spatio-temporal signature.

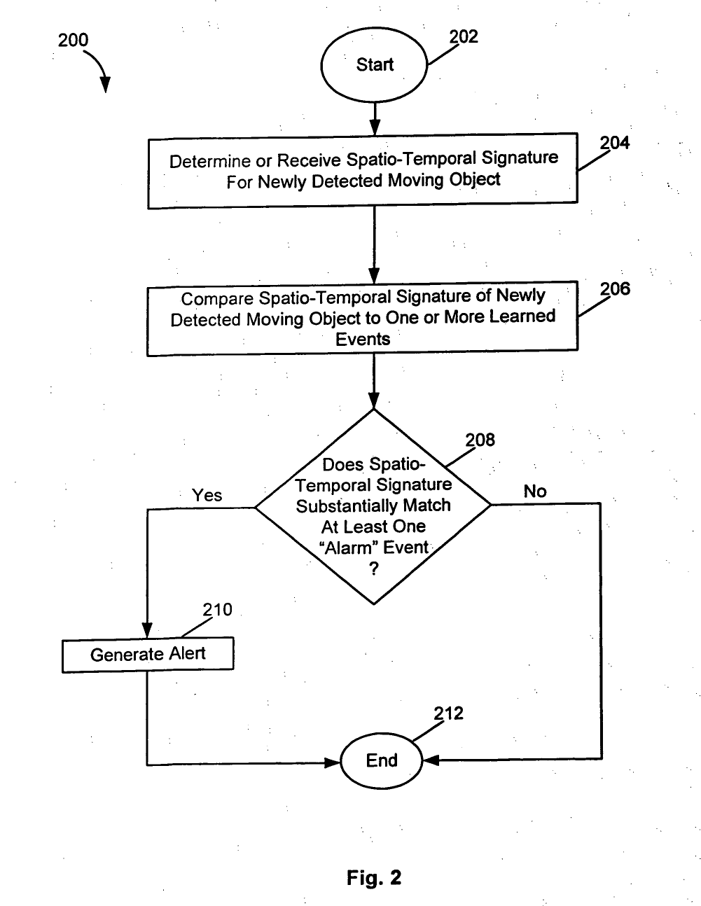

In yet another embodiment, the determination of whether to generate an alert is based on a comparison of the detected object's spatio-temporal signature to one or more learned (e.g., stored) spatio-temporal signatures representing known “alarm” conditions. As discussed in further detail below with respect to FIG. 2, the method 100 may have access to a plurality of learned examples of “alarm” conditions (e.g., conditions under which an alert should be generated if matched to a detected spatio-temporal signature) and “non-alarm” conditions (e.g., conditions under which an alert should not be generated if matched to a detected spatio-temporal signature).

If the method 100 determines in step 110 that an alert should be generated, the method 100 proceeds to step 112 and generates the alert. In one embodiment, the alert is an alarm (e.g., an audio alarm, a strobe, etc.) that simply announces the presence of a moving object in the field of view or the existence of an alarm condition. In another embodiment, the alert is a control signal that instructs the motion detection system to track the detected moving object.

After generating the alert, the method 100 returns to step 104 and continues to monitor the field of view, proceeding as described above when/if other moving objects are detected. Alternatively, if the method 100 determines in step 110 that an alarm should not be generated, the method 100 returns directly to step 104.

The method 100 thereby provides improved surveillance and motion detection by defining a moving object according to a plurality of feature vectors (e.g., the spatio-temporal signature), rather than according to just a single feature vector (e.g., flow). The plurality of feature vectors that comprise the spatio-temporal signature provides a richer set of information about a detected moving object than existing algorithms that rely on a single feature vector for motion detection. For example, while an existing motion detection algorithm may be able to determine that a detected object is moving across the field of view at x pixels per second, the method 100 is capable of providing additional information about the detected object (e.g., the object moving across the field of view at x pixels per second is a person running). By focusing on the spatio-temporal signature of an object relative to one or more spatio-temporal signatures associated with the background scene in which the object is moving, false alarms for background motion such as swaying trees, flowing water and weather conditions can be substantially reduced. Moreover, as discussed, the method 100 is capable of classifying detected objects according to their spatio-temporal signatures, providing the possibility for an even higher degree of motion detection and alert generation accuracy.

FIG. 2 is a flow diagram illustrating one embodiment of a method 200 for determining whether to generate an alert in response to a newly detected moving object (e.g., in accordance with step 110 of the method 100), according to the present invention. Specifically, the method 200 determines whether the newly detected moving object is indicative of an alarm event or condition by comparing it to previously learned alarm and/or non-alarm events. The method 200 is initialized at step 202 and proceeds to step 204, where the method 200 determines or receives the spatio-temporal signature of a newly detected moving object.

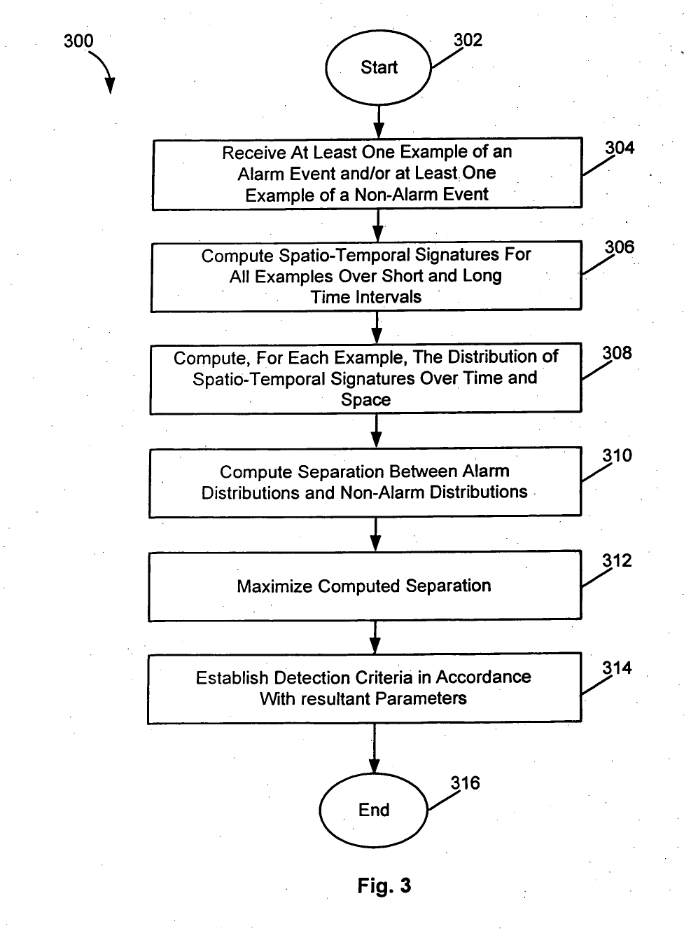

In step 206, the method 200 compares the spatio-temporal signature of the newly detected moving object to one or more learned events. In one embodiment, these learned events include at least one of known alarm events and known non-alarm events. In one embodiments, these learned events are stored (e.g., in a database) and classified, as described in further detail below with respect to FIG. 3.

In step 208, the method 200 determines whether the spatio-temporal signature of the newly detected moving object substantially matches (e.g., resembles within a predefined threshold of similarity) or fits the criteria of at least one learned alarm event. If the method 200 determines that the spatio-temporal signature of the newly detected moving object does substantially match at least one learned alarm event, the method 200 proceeds to step 210 and generates an alert (e.g., as discussed above with respect to FIG. 1). The method 200 then terminates in step 212. Alternatively, if the method 200 determines in step 208 that the spatio-temporal signature of the newly detected moving object does not substantially match at least one learned alarm event, the method 200 proceeds directly to step 212.

FIG. 3 is a flow diagram illustrating one embodiment of a method 300 for learning alarm events (e.g., for use in accordance with the method 200), according to the present invention. The method 300 is initialized at step 302 and proceeds to step 304, where the method 300 receives or retrieves at least one example (e.g., comprising video footage) of an exemplary alarm event or condition and/or at least one example of an exemplary non-alarm event or condition. For example, the example of the alarm event might comprise footage of an individual running at high speed through an airport security checkpoint, while the example of the non-alarm event might comprise footage of people proceeding through the security checkpoint in an orderly fashion.

In step 306, the method 300 computes, for each example (alarm and non-alarm) received in step 304, the spatio-temporal signatures of moving objects detected therein over both long and short time intervals (e.g., where the intervals are “long” or “short” relative to each other). In one embodiment, the core elements of the computed spatio-temporal signatures include at least one of instantaneous size, position, velocity and acceleration. In one embodiment, detection of these moving objects is performed in accordance with the method 100.

In step 308, the method 300 computes, for each example, the distribution of spatio-temporal signatures over time and space, thereby providing a rich set of information characterizing the activity occurring in the associated example. In one embodiment, the distributions of the spatio-temporal signatures are computed in accordance with methods similar to the textural analysis of image features.

In step 310, the method 300 computes the separation between the distributions calculated for alarm events and the distributions calculated for non-alarm conditions. In one embodiment, the separation is computed dynamically and automatically, thereby accounting for environmental changes in a monitored field of view or camera changes over time. In further embodiments, a user may provide feedback to the method 300 defining true and false alarm events, so that the method 300 may learn not to repeat false alarm detections.

Once the distribution separation has been computed, the method 300 proceeds to step 312 and maximizes this separation. In one embodiment, the maximization is performed in accordance with standard methods such as Fisher's linear discriminant.

In step 314, the method 300 establishes detection criteria (e.g., for detecting alarm conditions) in accordance with one or more parameters that are the result of the separation maximization. In one embodiment, establishment of detection criteria further includes grouping similar learned examples of alarm and non-alarm events into classes of events (e.g., agitated people vs. non-agitated people). In one embodiment, event classification can be performed in accordance with at least one of manual and automatic processing. In further embodiments, establishment of detection criteria further includes defining one or more supplemental rules that describe when an event or class of events should be enabled or disabled as an alarm event. For example, the definition of an alarm condition may vary depending on a current threat level, the time of day and other factors (e.g., the agitated motion of a person might be considered an alarm condition when the threat level is high, but a non-alarm condition when the threat level is low). Thus, the supplemental rules are not based on specific criteria (e.g., direction of motion), but on the classes of alarm and non-alarm events.

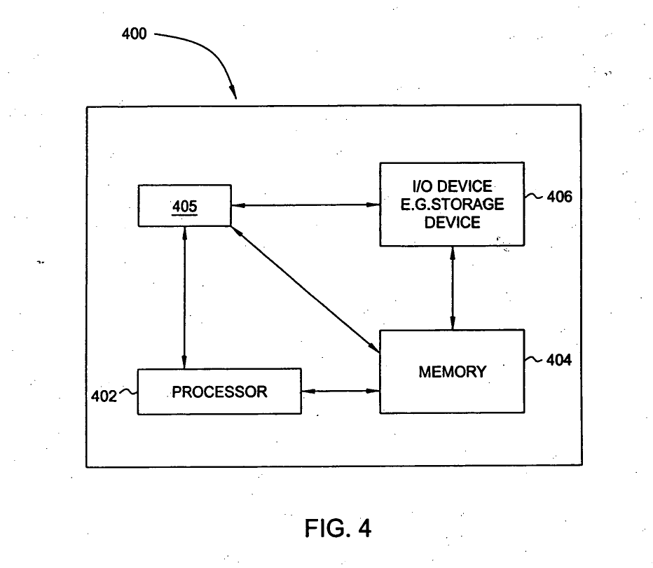

FIG. 4 is a high level block diagram of the surveillance method that is implemented using a general purpose computing device 400. In one embodiment, a general purpose computing device 400 comprises a processor 402, a memory 404, a surveillance module 405 and various input/output (I/O) devices 406 such as a display, a keyboard, a mouse, a modem, and the like. In one embodiment, at least one I/O device is a storage device (e.g., a disk drive, an optical disk drive, a floppy disk drive). It should be understood that the surveillance module 405 can be implemented as a physical device or subsystem that is coupled to a processor through a communication channel.

Alternatively, the surveillance module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the surveillance module 405 for performing surveillance in secure locations described herein with reference to the preceding Figures can be stored on a computer readable medium or carrier (e.g., RAM, magnetic or optical drive or diskette, and the like).

Thus, the present invention represents a significant advancement in the field of video surveillance and motion detection. A method and apparatus are provided that enable improved surveillance and motion detection by defining a moving object according to a plurality of feature vectors (e.g., the spatio-temporal signature), rather than according to just a single feature vector (e.g., flow). By focusing on the spatio-temporal signature of an object relative to a spatio-temporal signature of the background scene in which the object is moving, false alarms for background motion such as swaying trees, flowing water and weather conditions can be substantially reduced. Moreover, the method and apparatus are capable of classifying detected objects according to their spatio-temporal signatures, providing the possibility for an even higher degree of accuracy.

While the foregoing is directed to embodiments of the present invention, other and further embodiments of the invention may be devised without departing from the basic scope thereof, and the scope thereof is determined by the claims that follow.

1. A method for performing surveillance of a field of view, comprising:
monitoring said field of view; and
detecting a moving object in said field of view, in accordance with a spatio-temporal signature of said moving object.

2. The method of claim 1, wherein said spatio-temporal signature comprises a plurality of feature vectors that describe said moving object and a motion of said moving object over a space-time interval.

3. The method of claim 1, wherein said detecting comprises:
determining one or more spatio-temporal signatures associated with a background scene of said field of view;
determining a spatio-temporal signature of said moving object; and
determining that said spatio-temporal signature of said moving object does not represent a portion of said background scene as defined by said one or more spatio-temporal signatures associated with said background scene.

4. The method of claim 1, further comprising:
classifying said moving object in accordance with said spatio-temporal signature.

5. The method of claim 4, wherein said classifying comprises:
comparing said spatio-temporal signature of said moving object to one or more spatio-temporal signatures representing known objects;
identifying at least one known object that said moving object most closely resembles based on said spatio-temporal signature of said moving object and said one or more spatio-temporal signatures representing known objects; and
creating a new class if said spatio-temporal signature of said moving object does not resemble, within a predefined threshold of similarity, at least one of said one or more spatio-temporal signatures representing known objects.

6. The method of claim 5, wherein information relating to said one or more spatio-temporal signatures representing known objects is stored in a database.

7. The method of claim 1, further comprising:
generating an alert if said moving object is indicative of one or more alarm conditions.

8. The method of claim 7, wherein said moving object is indicative of one or more alarm conditions if said spatio-temporal signature of said moving object resembles, within a predefined threshold of similarity, one or more spatio-temporal signatures associated with known alarm conditions.

9. The method of claim 8, wherein information relating to said one or more spatio-temporal signatures associated with known alarm conditions is stored in a database.

10. The method of claim 9, wherein said database is built based on at least one previously observed alarm condition and at least one previously observed non-alarm condition.

11. The method of claim 10, wherein said building of said database comprises:
computing a difference between said at least one previously observed alarm condition and at least one previously observed non-alarm condition, in accordance with one or more spatio-temporal signatures representing said at least one previously observed alarm condition and one or more spatio-temporal signatures representing at least one previously observed non-alarm condition; and
establishing criteria for detecting said known alarm conditions in accordance with said difference.

12. The method of claim 11, wherein said computing comprises:
calculating said one or more spatio-temporal signatures representing said at least one previously observed alarm condition and said one or more spatio-temporal signatures representing at least one previously observed non-alarm condition;
calculating a first distribution, over time and space, of said one or more spatio-temporal signatures representing said at least one previously observed alarm condition;
calculating a second distribution, over time and space, of said one or more spatio-temporal signatures representing at least one previously observed non-alarm condition; and
calculating a separation between said first distribution and said second distribution.

13. The method of claim 12, wherein said establishing comprises:
maximizing said separation; and
defining said criteria in accordance with one or more parameters resulting from said maximization.

14. The method of claim 11, further comprising:
grouping said at least one previously observed alarm condition into two or more classes of alarm conditions; and
grouping said at least one previously observed non-alarm condition into two or more classes of non-alarm conditions.

15. A computer-readable medium having stored thereon a plurality of instructions, the plurality of instructions including instructions which, when executed by a processor, cause the processor to perform the steps of a method of performing surveillance of a field of view, comprising:
monitoring said field of view; and
detecting a moving object in said field of view, in accordance with a spatio-temporal signature of said moving object.

16. The computer-readable medium of claim 15, wherein said spatio-temporal signature comprises a plurality of feature vectors that describe said moving object and a motion of said moving object over a space-time interval.

17. The computer-readable medium of claim 15, wherein said detecting comprises:
determining one or more spatio-temporal signatures associated with a background scene of said field of view;
determining a spatio-temporal signature of said moving object; and
determining that said spatio-temporal signature of said moving object does not represent a portion of said background scene as defined by said one or more spatio-temporal signatures associated with said background scene.

18. The computer-readable medium of claim 15, further comprising:
classifying said moving object in accordance with said spatio-temporal signature.

19. The computer-readable medium of claim 18, wherein said classifying comprises:
comparing said spatio-temporal signature of said moving object to one or more spatio-temporal signatures representing known objects;
identifying at least one known object that said moving object most closely resembles based on said spatio-temporal signature of said moving object and said one or more spatio-temporal signatures representing known objects; and
creating a new class if said spatio-temporal signature of said moving object does not resemble, within a predefined threshold of similarity, at least one of said one or more spatio-temporal signatures representing known objects.

20. An apparatus for performing surveillance of a field of view, comprising:
means for monitoring said field of view; and
means for detecting a moving object in said field of view, in accordance with a spatio-temporal signature of said moving object.
